(19) United States
(12) Patent Application Publication
(10) Pub. No.: US 2017/0132198 A1
(43) Pub. Date: May 11, 2017

(54) PROVIDE INTERACTIVE CONTENT GENERATION FOR DOCUMENT

(71) Applicant: MICROSOFT TECHNOLOGY LICENSING, LLC, Redmond, WA (US)

(72) Inventors: Shikha Desai, Redmond, WA (US); Jack Richins, Bothell, WA (US); Clay Satterfield, Redmond, WA (US); Vincent Pasceri, Bothell, WA (US); Dennis Krut, Bellevue, WA (US); Anton Shumikhin, Redmond, WA (US); Alexander Livingston, Seattle, WA (US); Kevin Gaunt, Seattle, WA (US); Allison Gallant, Seattle, WA (US); Paul Scudieri, Seattle, WA (US); YuBeen Lee, Redmond, WA (US)

(21) Appl. No.: 14/938,583

(22) Filed: Nov. 11, 2015

(51) Int. Cl. G06F 17/24; G06F 3/16

(52) U.S. Cl. CPC G06F 17/248; G06F 3/16

(57) ABSTRACT

Interactive generation of content is provided for a document. An application, such as a document processing application, detects an intent to create the document based on an input or an inference. The input includes a selection from a set of content structure templates. The inference includes a threshold based event such as a deadline, a reminder, and/or a presence of an editor detected in a specific location, among others. Next, a content structure template based on the document is presented. The content structure template includes question(s) associated with the document. Received answer(s) to the question(s) are combined to generate a document

### BACKGROUND

People interact with computer applications through user interfaces. While audio, tactile, and similar forms of user interfaces are available, visual user interfaces through a display device are the most common form of a user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications provide document management. Initiating the creation process to generate content includes a variety of challenges.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to interactive generation of content for a document. In some examples, a document processing application may detect an intent to create a document based on an input or an inference. In response, a content structure template based on the document may be presented. The content structure template may include questions associated with the document. Next, answers to the questions may be received. The document may be generated based on the answers.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of providing interactive generation of content for a document, according to embodiments;

FIG. 2 is a display diagram illustrating an example of a document processing application that provides interactive generation of content for a document, according to embodiments;

FIG. 3 is a display diagram illustrating an example of user interfaces of a document processing application that provides interactive generation of content for a document, according to embodiments;

FIG. 4 is a display diagram illustrating an example of a document with content that is interactively generated, according to embodiments;

FIG. 5 is a display diagram illustrating schemes to customize interactive generation of content for a document, according to embodiments;

FIG. 6 is a simplified networked environment, where a system according to embodiments may be implemented;

FIG. 7 is a block diagram of an example computing device, which may be used to provide interactive generation of content for a document; and

FIG. 8 is a logic flow diagram illustrating a process for providing interactive generation of content for a document, according to embodiments.

### DETAILED DESCRIPTION

As briefly described above, interactive generation of content for a document may be provided by a document processing application. In an example scenario, an intent to create a document may be detected based on an input or an inference. The input may include an audio stream of a command to generate the document. The inference may include a threshold based event such as to deadline, a reminder, and/or a detected presence in a location, among others that may be detected as a prerequisite to generate the document. A content structure template based on the document may be presented in response to the detected intent. The content structure template may include questions associated with the document. The content structure template may be selected from a set of the content structure templates based on a matching set of attributes extracted from the input or the inference.

The document processing application may receive answers to the presented questions. The answers may include content portions which may be compiled to generate a section of the document. The questions and the corresponding answers may be presented to allow for a customization of the answer or the questions. Next, the document may be generated based on the answers.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide interactive generation of content for a document. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

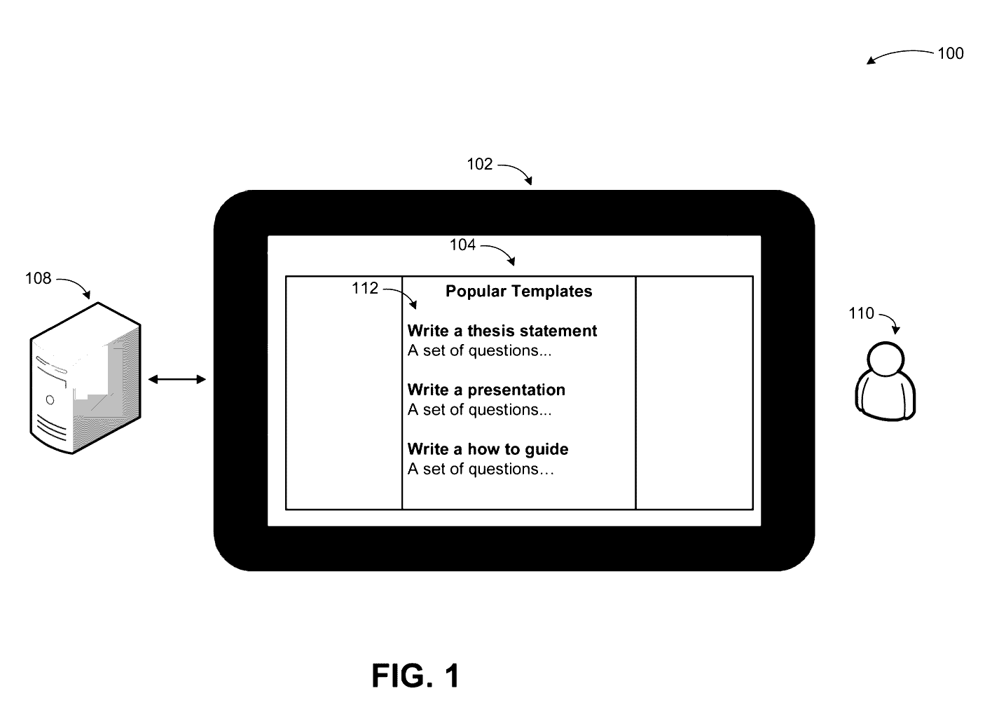

FIG. 1 is a conceptual diagram illustrating an example of providing interactive generation of content for a document, according to embodiments.

In a diagram 100, a computing device 102 may execute a document processing application 104. The document processing application 104 may include a communication management application, a document presentation application, a document editing application among others. The computing device 102 may include a tablet device, a laptop computer a desktop computer, and a smart phone, among others. The computing device 102 may also include a special purpose computing device configured to provide document management through a display component configured to display one or more documents, a communication component configured to transmit one or more documents, and/or a storage component configured to store one or more documents, among other components.

The computing device 102 may display the document processing application 104 to an editor 110. The editor may include an entity such as a student, and/or a professional, among others. The editor 110 may be allowed to interact with the document processing application 104 through an input device or touch enabled display component of the computing device 102. The computing device 102 may also include a display device such as the touch enabled display component, and a monitor, among others to provide the document processing application 104 to the editor 110.

The document processing application 104 may detect an intent to create a document based on input or an inference. In response, a content structure template 112 based on the document may be presented to the editor 110. The content structure template 112 may include question(s) associated with the document. Answer(s) to the question(s) may be used to generate the document. The input, and/or the answer(s) may be provided or captured by an audio and/or video component of the computing device 102. The captured audio and/or video input streams may be converted to text data and provided as associated input or answer(s). The question(s) may be played as audio output streams through the audio and/or video component of the computing device 102.

The content structure template 112 may be stored locally within the computing device 102. Alternatively, the content structure template 112 may be retrieved from a server 108 that hosts and manages content structure templates associated with documents and content of the documents.

The server 108 may include a content server and/or a document management server, among others. The computing device 102 may communicate with the server 108 through a network. The network may provide wired or wireless communications between nodes such as the computing device 102, or the server 108, among others.

The editor 110 may interact with the document processing application 104 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the computing device 102, the document processing application 104, embodiments are not limited to these components or system configurations and can be implemented with other system configuration employing fewer or additional components.

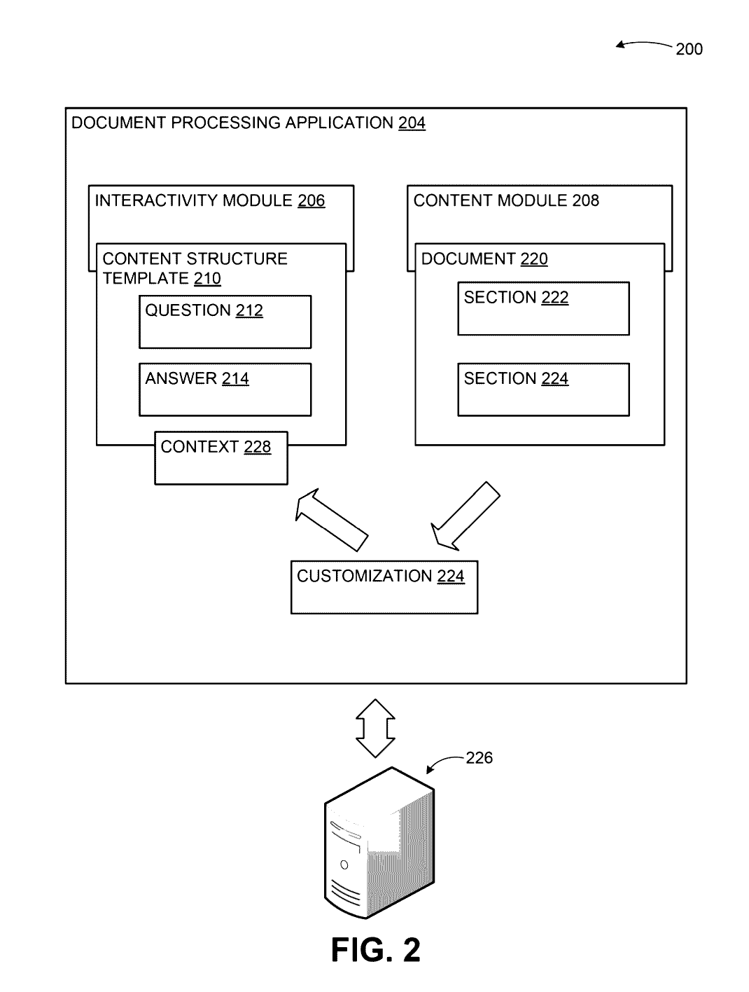

FIG. 2 is a display diagram illustrating an example of a document processing application that provides interactive generation of content for a document, according to embodiments.

In a diagram 200, a document processing application 204 may interact with an editor to generate one or more sections of a document 220. The document processing application 204 may include an interactivity module 206 and a content module 208. The interactivity module 206 may execute processes associated with displaying user interfaces and capturing input provided through the user interfaces. The content module 208 may execute processes associated with analysis of input and generation of the document 220.

The interactivity module 206 of the document processing application 204 may detect an input or an inference to generate the document 220 or a section (222 or 224) of the document 220. The input may include attributes associated with the document or the section (222 or 224) such as a title, a type, or a subject of the document 220 or the section (222 or 224). The section (222 or 224) may include a title, a subheading, a paragraph, a page, and/or a footnote, among others.

The inference may include a threshold based event such as a deadline, a reminder, and/or a detected presence in a location, among others. The content module 208 may process the inference. In response to a detection of passing the threshold based event such as passing the deadline, delivery of the reminder, the presence of the editor at a specific location, the inference may be processed to identify one or more attributes associated with the document 220 or the section (222 or 224) of the document. Alternatively, if the input is detected, the input may be processed by the content module 208 to match one or more attributes associated with the document 220 or the section (222 or 224). The attributes may be matched to the content structure template 210 from a set of content structure templates.

The content structure template 210 may include one or more questions such as a question 212. The question 212 may include an information request associated with the document 220. For example, in response to a student's input to generate a term paper, the interaction template 210 associated with a term paper may be selected. The question 212 associated with the term paper may be presented to the student to request information about the specifics of the term paper such as a topic, and/or an outline structure, among others.

The content module 208 may use a context 228 associated with the input or the inference to select the content structure template 210. An external source 226 may be queried to search for the content 228 associated with the input or the inference. The context 228 may include personal information associated with the editor such as a correlation between the input and a residence of the editor. For example, the editor such as a student may be identified to reside at a business school. The context 228 associated with the business school may be used to select the content structure template 210 associated with a business studies related topic. The external source 226 may include a personnel server, a human resources server, a social networking server, and/or a professional networking server, among others.

Furthermore, an answer 214 may be received by the content module 208 to the question 212. The answer 214 may include information associated with the document 220 or the section (222 or 224) of the document 220. The question 212 and the answer 214 among other questions and answers may be displayed to the editor by the interactivity module 206 to allow the editor to provide a customization 224 of the question 212 or the answer 214. The customization 224 of the question 212 may be saved to the content structure template 210 for future use.

The answer 214 or other answers captured by the interactivity module 206 in relation to the content structure template 210 may be combined to generate the document 220 or a section (222 or 224) of the document 220. The structure used to map the answers to a location on the document may be described in the content structure template 210. For example, the question 212 and the answer 214 may be mapped to a topic of the section 222 such as a paragraph of the document 220. The answer 214 may be inserted into the document 220 as an initial sentence of the section 222.

The structure of the document 220 or the section (222 or 224) that maps the answer 214 to a specific location in the document 220 or the section (222 or 224) may be provided to the editor to allow the editor to customize the structure.

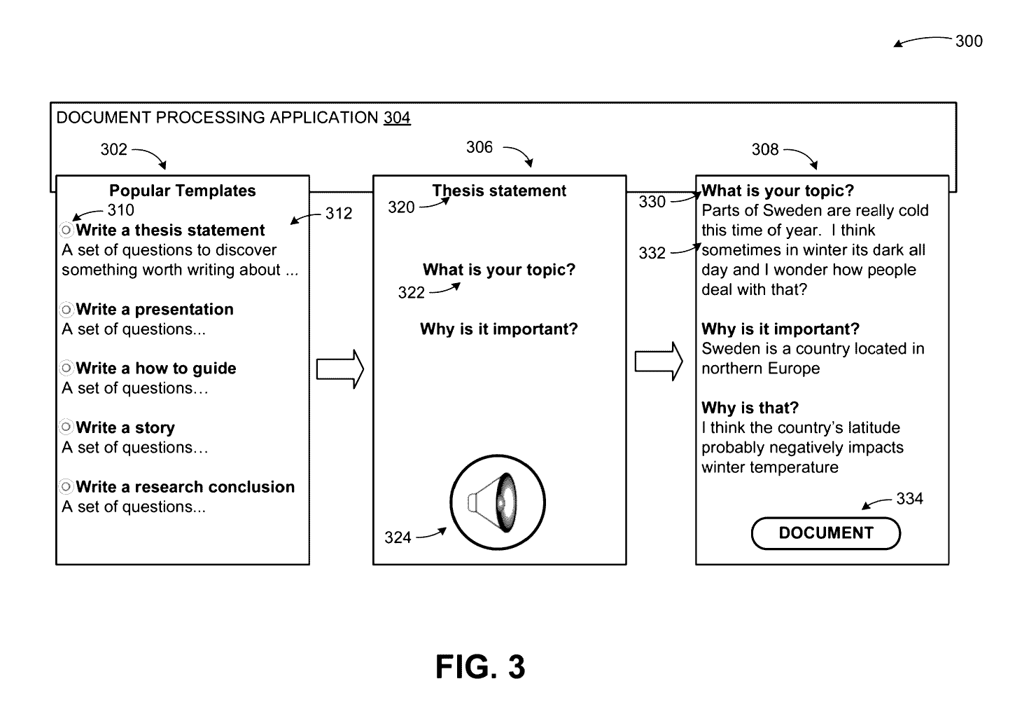

FIG. 3 is a display diagram illustrating an example of user interfaces of a document processing application that provides interactive generation of content for a document, according to embodiments.

In a diagram 300, a document processing application 304 may present one or more user interfaces (302, 304, or 306) to an editor to request answers to questions to generate a document. A user interface 302 may provide a set of content structure templates 312 to request an input as an intent to create the document. The input may be a selection of one of the presented set of content structure templates. An element 310 may be used to select the content structure template to be used to generate the document. For example, the element 310 may be selected to activate a content structure template 320 to generate a thesis statement. The document processing application 304 may capture the input as a tactile feedback such as a touch action on the element 310 or as an audio input. stream. The audio input stream may be used to select the content structure template 320.

Next, the document processing application 304 may display a user interface 306. The user interface 306 may provide the content structure template 320 which may include a question 322 or other questions. The question 322 may be displayed to capture an answer associated with the document for use in generating the document. The questions may also be played as audio output streams to the editor of the document. An element 324 may also be provided to execute operations associated with capturing the answer to the question 322 and other answers to other questions through audio input streams. The audio input streams may be converted to text based data which may be used as the answer to the question 322 or other answers to other questions of the content structure template 320.

Next, the document processing application 304 may display a user interface 308 that may include the question 330 and the answer 332 and other questions and other answers of the content structure template 320. The question 330 and the answer 332 (and other questions and answers) may be customizable by the editor. A customization to the question 330 may be used to modify the content structure template 320. The modified content structure template may be saved for future use. The customization to the answer 332 or other answers may be used to further customize the document or a section of the document. An element 334 may also be provided to generate the document or a section of the document by combining the answer 332 with other answer(s) captured through the content structure template 320.

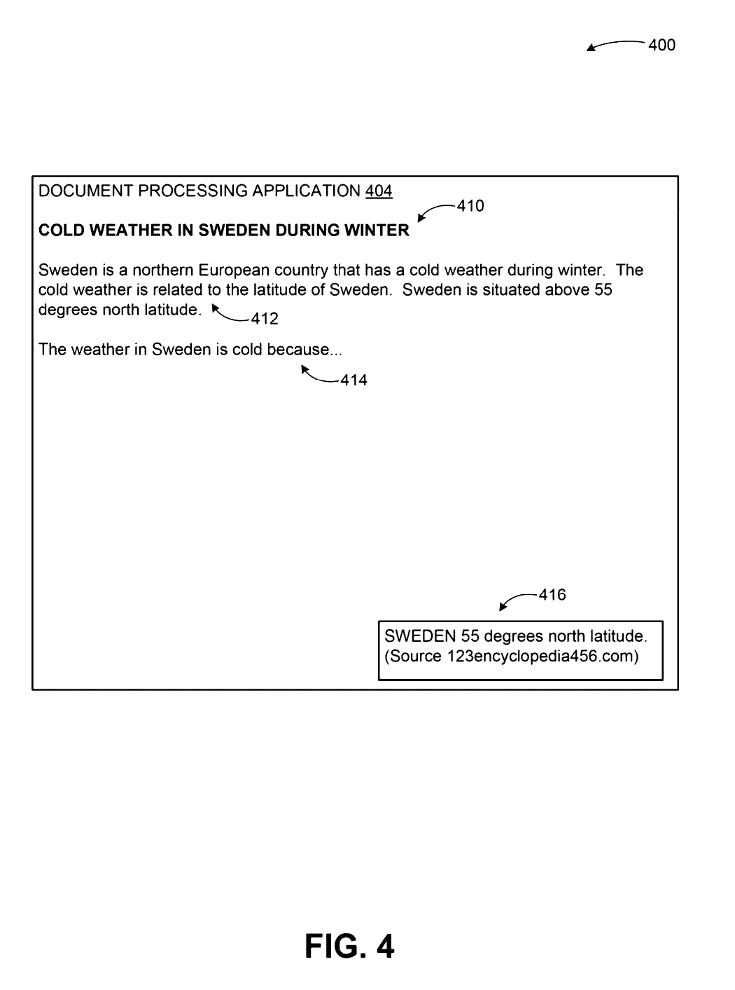

FIG. 4 is a display diagram illustrating an example or a document with content that is interactively generated, according to embodiments.

In a diagram 400, a document processing application 404 may present the document generated from answers to questions of a content structure template. The document may include multiple sections. The section 410 may be a title section which may be generated from a question asking about the title of the document. The section 410 may be generated with information from the answer as well as information from external resources. The information from external resources may be provided as a prompt 416 to request a validation of the information and customize the information to prevent issues with plagiarism.

The sections 412 and 414 may also be generated based on answers to the questions of the content structure template. Control elements may be provided to allow the editor to customize the sections (410, 412, or 414). Furthermore, historical use of the content structure templates may be captured to analyze and generate additional inferences based on the historical use. For example, a frequently used content structure template may be suggested as primary choice for a selection to allow an editor to generate a document. The frequency of use and recentness of use may be continually processed to rank the content structure templates to be provided as choices for the selection.

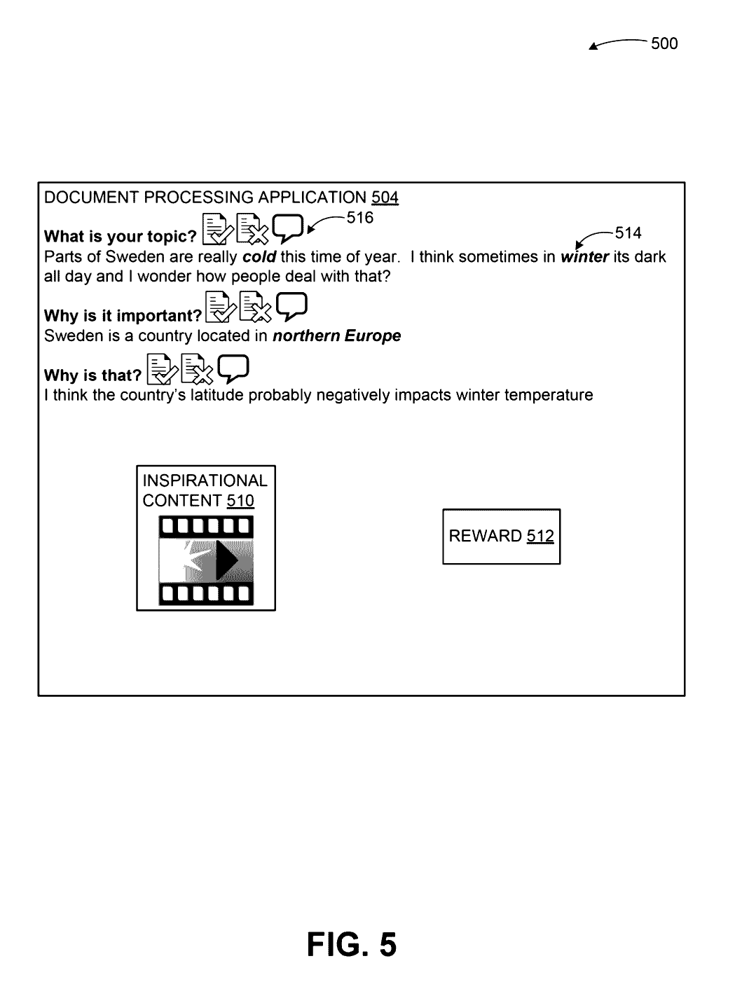

FIG. 5 is a display diagram illustrating schemes to customize interactive generation of content for a document, according to embodiments.

In a diagram 500, a document processing application 504 may provide a content structure template. The content structure template may include questions to capture answers for use in generating a document. Feedback elements 516 may be provided with each question to capture feedback associated with the questions. Feedback such as positive feedback and negative feedback may be aggregated and provided, to a creator of the content structure template. The feedback may be used to inform the creator of a success associated with the question in capturing an editor's reasoning in relation to the content structure template and the work that the editor wishes to accomplish. The feedback elements 516 may also include a feedback capture element to capture written feedback associated with the question. The written feedback may be provided to the creator of the content structure template to allow the creator to further gain insight on a success of the question and/or the content structure template to capture an editor's reasoning in relation to the work that the editor wishes to accomplish.

An inspirational content 510 may be provided by the document processing application 504. The inspirational content 510 may include an audio stream, a video stream, an image, and/or a text based content, among others associated with attributes detected in the answers to questions of the content structure template. The attributes may include a title, a subject, an interest, and/or a keyword, among others associated with the document or a section of the document to be generated. A content provider may be searched for the inspirational content 510 that matches one or more of the detected attributes. The inspirational content 510 that matches one or more of the detected attributes may be provided to inspire the editor in relation to the work that the editor wishes to complete. For example, a term paper based content structure template may capture keywords in relation to the term paper such as one or more subjects. The key terms may be matched to the inspirational content 510 (such as a video stream) in a local content provider or an external content provider. The inspirational content 510 may be retrieved and provided to the editor on a user interface of the document application 504. Control elements to manage the display of the inspirational content 510 may also be provided to manage a viewing of the inspirational content 510.

A reward 512 may also be provided based on answers to the questions of the content structure template. An example of the reward 512 may be based on a time of completion of the answers to the questions. The time of the completion may be transferred to a supervision entity that tracks a progress of the creation of the document or the section of the document. For example, a teacher may be provided with a date/time stamp of completion of an answer to each of the questions. The teacher may authorize extra credit for early completion of the answers as the reward 512. Alternatively, a marketing entity may provide a discount as the reward 512 for a merchandize to an editor who completes the answers to the questions to generate a document (such as a review) associated with a service or a product.

Content such as a key term 514 and other key terms may also be extracted from the answers to the questions of the content structure template. The key term 514 may include an attribute detected in the answer such as a title, a concept, a subject, and/or an interest, among others. The key term 514 may be used as a context for the document or a section of the document to insert content associated with the key term 514 into the document or the section. The key term 514 and other key terms may be detected based on frequency of use of the key term 514 (or other key terms) in relation to the editor and the content structure template. Other schemes may also be used to the detect the key term 514 such as content analysis to discover similarities between related words or sentences and selecting related combination of words or sentences as keywords. Examples of key word detection are not provided in a limiting sense.

As discussed above, the application may be employed to perform operations associated with providing interactive generation of content for a document. An increased user efficiency with the document processing application 104 may occur as a result of generating documents based on questions and answer captured through a content structure template. Additionally, presenting questions and capturing answers through a content structure template to generate a document may reduce processor load, increase processing speed, conserve memory, and reduce network bandwidth usage.

Embodiments, as described herein, address a need that arises from a lack of efficiency between the editor 110 interacting with the document processing application 104 of the computing device 102. The actions/operations described herein are not a mere use of a computer, but address results that are a direct consequence of software used as a service offered to large numbers of users and applications.

The example scenarios and schemas in FIG. 1 through 5 are shown with specific components, data types, and configurations. Embodiments are not limited to systems according to these example configurations. Providing interactive generation of content for a document may be implemented in configurations employing fewer or additional components in applications and user interfaces. Furthermore, the example schema and components shown in FIG. 1 through 5 and their subcomponents may be implemented in a similar manner with other values using the principles described herein.

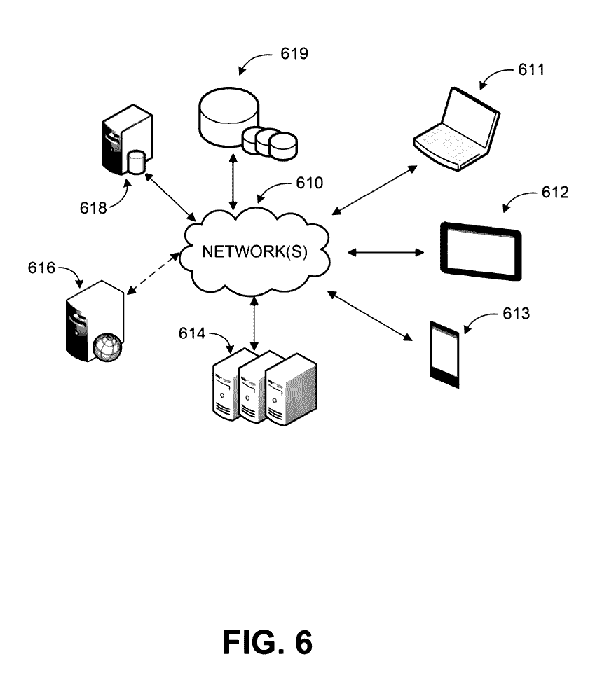

FIG. 6 is an example networked environment, where embodiments may be implemented. A document processing application configured to provide interactive generation of content for a document may be implemented via software executed over one of more servers 614 such as a hosted service. The platform may communicate with client applications on individual computing devices such as a smart, phone 613, a mobile computer 612, or desktop computer 611 (‘client devices’) through network(s) 610.

Client applications executed on any of the client devices 611-613 may facilitate communications via application(s) executed by servers 614, or on individual server 616. A document processing application may detect an intent to create a document based on an input or an inference. A content structure template based on the document may be presented. The content structure template may include questions associated with the document. Next, answers to the questions may be received. The document may be generated based on the answers. The document processing application may store data associated with the document in data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic. RF, infrared and other wireless media.

Many other configurations of computing devices, applications, data sources, and data distribution systems may be employed to provide interactive generation of content for a document. Furthermore, the networked environments discussed in FIG. 6 are for illustration purposes only. Embodiments are not limited to the example applications, modules, or processes.

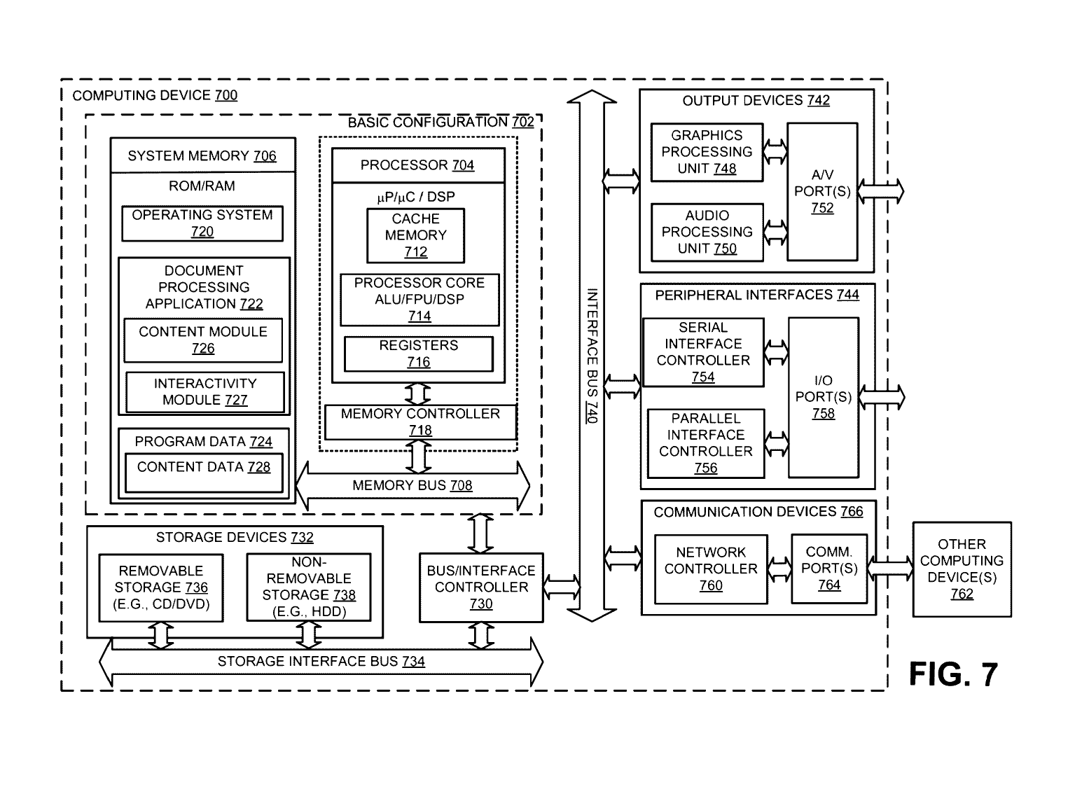

FIG. 7 is a block diagram of an example computing device, which may be used to provide interactive generation of content for a document.

For example, computing device 700 may be used as a server, desktop computer, portable computer, smart phone, special purpose computer, or similar device. In an example basic configuration 702, the computing device 700 may include one or more processors 704 and a system memory 706. A memory bus 70$ may be used for communication between the processor 704 and the system memory 706. The basic configuration 702 may be illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations, the memory controller 718 may be an internal part of the processor 704.

Depending on the desired configuration, the system memory 706 may be of any type including but not limited to volatile memory (such as RAM), non-volatile memory (such as ROM, flash memory, etc.), or any combination thereof. The system memory 706 may include an operating system 720, a document processing application 722, and a program data 724. The document processing application 722 may include components such as a content module 726 and an interactivity module 727. The content module 726 and the interactivity module 727 may execute the processes associated with the document processing application 722. The interactivity module 727 may detect an intent to create a document based on an input or an inference. A content structure template based on the document may be presented by the interactivity module 727. The content structure template may include questions associated with the document. Next, the content module 726 may receive answers to the questions. The document may be generated based on the answers by the content module 726.

Components of the document processing application 722 (such as a user interface) may also be displayed on a display device associated with the computing device 700. An example of the display device may include a hardware screen that may be communicatively coupled to the computing device 700. The display device may include a touch based device that detects gestures such as a touch action. The display device may also provide feedback in response to detected gestures (or any other form of input) by transforming a user interface of the document processing application 722, displayed by the touch based device. The program data 724 may also include, among other data, content data 728, or the like, as described herein. The content data 728 may include a document, and/or a content structure template, among others.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology. CD-ROM, digital versatile disks (DVDs), solid state drives, or other optical storage, magnetic cassettes, magnetic tape, magnetic disk storage or other magnetic storage devices, or any other medium which may be used to store the desired information a id which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the basic configuration 702 via the bus/interface controller 730. Some of the example output devices 742 include a graphics processing, unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device etc.) or other peripheral devices (for example, printer, scanner, etc.) via one or more I/O ports 758. An example communication device 766 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network, or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer, which includes any of the above functions. The computing device 700 may also be implemented as a personal computer including both laptop computer and non-laptop computer configurations.

Example embodiments may also include methods to provide interactive generation of content for a document. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

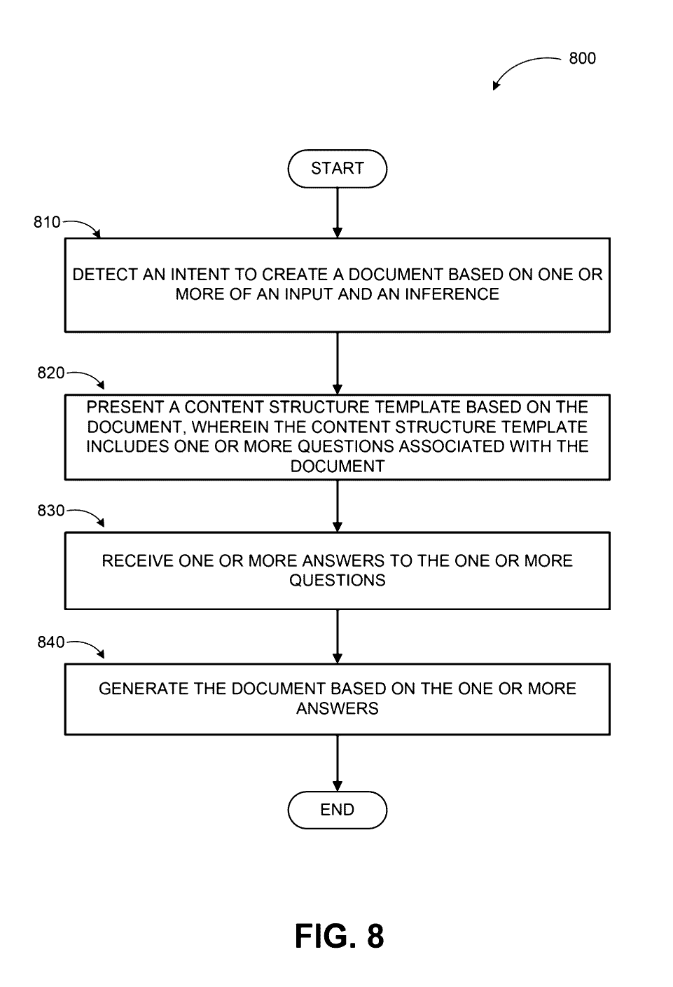

FIG. 8 is a logic flow diagram illustrating a process for providing interactive generation of content for a document, according to embodiments. Process 800 may be implemented on a computing device, such as the computing device 700 or another system.

Process 800 begins with operation 810, where a document processing application may detect an intent to create a document based on an input or an inference. The input may include a selection of one from a set of content structure templates. The inference may include a threshold based event such as a deadline, a reminder, and/or a presence of an editor detected in a specific location, among others. At operation 820, a content structure template based on the document may be presented. The cement structure template may include question(s) associated with the document.

At operation 830, answer(s) to the question(s) may be received. The answer(s) may be combined to generate a section of a document or the document based on a structure that maps the answers to locations in the document or the section of the document as provided by the content structure template. At operation 840, the document may be generated based on the answer(s).

According to some examples a computing device for providing interactive generation of content for a document is described. The computing device includes a display device, a memory configured to store instructions associated with a document processing application, and one or more processors coupled to the memory and the display device. The one or more processors execute the document processing application in conjunction with the instructions stored in the memory. The document processing application includes an interactivity module and a content module. The interactivity module is configured to detect an intent to create a document based on one or more of an input and an inference and present, on the display device, a content structure template based on the document, where the content structure template includes one or more questions associated with the document. The content module is configured to receive one or more answers to the one or more questions; and generate the document based on the one or more answers.

According to other examples, the content module is further configured to detect the input as the intent to create the document, identify an audio stream as the input, and convert the audio stream to a text data with voice recognition. The content module is further configured to process the text data to identify one or more attributes associated with the document, where the one or more attributes include one or more of: a title of the document, a type of the document, and a subject of the document and match the one or more attributes associated with the document to the content structure template by comparing the one or more attributes associated with the document to a set of content structure templates.

According to further examples, the content module is further configured to detect the inference as the intent to create the document, were the inference includes one or more of: a deadline, a reminder, and a detected presence in a location, process the inference to identify one or more attributes associated with the document, where the one or more attributes include one lore of a title of the document, a type of the document, and a subject of the document, and match the one or more attributes associated with the document to the content structure template by comparing the one or more attributes associated with the document to a set of content structure templates.

According to other examples, the interactivity module is further configured to display, on the display device, a label associated with the content structure template, where the label describes a subject of the one or more questions and capture the one or more answers to the one or more questions provided as a written input. The interactivity module is further configured to play one or more audio output streams that include one or more questions of the content structure template, capture one or more audio input streams as the one or more answers to the One or more questions, provide the one or more audio input streams to the content module, convert the one or more audio input streams into one or more text data, and process the one or more text data as the one or more answers to the one or more questions.

According to some examples, the content module is further configured to display the one or more answers that correspond to the one or more questions and provide one or more elements to allow for a customization of the one or more answers. The content module is further configured to detect an action to generate the document and combine the one or more answers to a section of the document based on a structure of the document that maps the one or more answers to the section of the document, create the document, and insert the section into the document. The content module is further configured to select the content structure template from a set of the content structure templates based on the intent to generate document, where the content structure template includes one or more of: a thesis statement, a project presentation, a how to guide, a story outline, a research conclusion, and a biography.

According to some examples, a method executed on a computing device for providing interactive generation of content for a document is described. The method includes detecting an intent to create a section of the document based on an input, presenting a content structure template based on the section of the document, where the content structure template includes one or more questions associated the section of the document, receiving one or more answers to the one or more questions, and generating the section of the document based on the one or more answers.

According to other examples, the method further includes querying an external source for context associated with the input, receiving the context associated with the input, processing the context to identify one or more attributes associated with the section of the document, and matching the one or more attributes associated with the section of the document to the content structure template from a set of content structure templates. The method further includes detecting a customization of the one or more questions and saving the customization to the content structure template. The method further includes querying an external source for information associated with one or more answers, receiving, the information associated with the one or more answers from the external source, integrating, the information associated with the one or more answers to the section of the document, and providing a prompt that describes the information associated with the one or more answers and the external source.

According to some examples, a computer-readable memory device with instructions stored thereon for providing interactive generation of content for a document is described. The instructions include actions similar to actions of the method.

According to some examples, a means for providing, interactive generation of content for a document is described. The means for providing interactive generation of content for a document includes a means for detecting an intent to create a document based on one or more of an input and an inference, a means for presenting a content structure template based on the document, where the content structure template includes one or more questions associated with the document, a means for receiving one or more answers to the one or more questions, and a means for generating the document based on the one or more answers.

The operations included in process 800 are for illustration purposes. Providing interactive generation of content for a document may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device for providing interactive generation of content for a document, the computing device comprising:
a display device;
a memory configured to store instructions associated with a document processing application;
one or more processors coupled to the memory and the display device, the one or more processors executing the document processing application in conjunction with the instructions stored in the memory, wherein the document processing application includes:
an interactivity module configured to:
detect an intent to create a document based on one or more of an input and an inference;
present, on the display device, a content structure template based on the document, wherein the content structure template includes one or more questions associated with the document; and
a content module configured to:
receive one or more answers to the one or more questions; and
generate the document based on the one or more answers.

2. The computing device of claim 1, wherein the content module is further configured to:
detect the input as the intent to create the document;
identify an audio stream as the input; and
convert the audio stream to a text data with voice recognition.

3. The computing device of claim 2, wherein the content module is further configured to:
process the text data to identify one or more attributes associated with the document, wherein the one or more attributes include one or more of: a title of the document, a type of the document and at subject Of the document; and
match the one or more attributes associated with the document to the content structure template by comparing the one or more attributes associated With the document to a set of content structure templates.

4. The computing device of claim 1, wherein the content module is further configured to:
detect the inference as the intent to create the document, wherein the inference includes one, or more of: a deadline, a reminder, and a detected presence in a location;
process the inference to identify one or more attributes associated with the document, wherein the one or more attributes include one or more of: a title of the document, a type of the document, and a subject of the document, and
match the one or more attributes associated with the document to the content structure template by comparing the one or more attributes associated with the document to a set of content structure templates.

5. The computing device of claim 1, wherein the interactivity module is further configured to:
display, on the display device, a label associated with the content structure template, wherein the label describes a subject of the one or more questions; and
capture the one or more answers to the one or more questions provided as a written input.

6. The computing device of claim 1, wherein the interactivity module is further configured to:
play one or more audio output streams that include one or more questions of the content structure template;
capture one or more audio input streams as the one or more answers to the one or more questions; and
provide the one or more audio input streams to the content nodule.

7. The computing device of claim 7, wherein the content module is further configured to:
convert the one or more audio input streams into one or more text data; and
process the one or more text data as the one or more answers to the one or more questions.

8. The computing device of claim 1, wherein the content module is further configured to:
display the one or more answers that correspond to the one or more questions; and
provide one or more elements to allow for a customization of the one or more answers.

9. The computing device of claim 1, Wherein the content module is further configured to:
detect an action to generate the document; and
combine the one or more answers to a section of the document based on a structure of the document that maps the one or more answers to the section of the document.

10. The computing device of claim 9, wherein the content module is further configured to:
create the document; and
insert the section into the document.

11. The computing device of claim 1, wherein the content module is further configured to:
select the content structure template from a set of the content structure templates based on the intent to generate document, wherein the content structure template includes one or more of: a thesis statement, a project presentation, a how to guide, a story outline, a research conclusion, and a biography.

12. A method executed on a computing device for providing interactive generation of content for a document, the method comprising:
detecting an intent to create a section of the document based on an input;
presenting a content structure template based on the section of the document, wherein the content structure template includes one or more questions associated the section of the document;
receiving one or more answers to the one or more questions; and
generating the section of the document based on the one or more answers.

13. The method of claim 12, further comprising:
querying an external source for context associated with the input; and
receiving the context associated with the input.

14. The method of claim 13, further comprising:
processing the context to identify one or more attributes associated with the section of the document; and
matching the one or more attributes associated with the section of the document to the content structure template from a set of content structure templates.

15. The method of claim 12, further comprising:
detecting a customization of the one or more questions; and
saving the customization to the content structure template.

16. The method of claim 12, further comprising:
querying an external source for information associated with one or more answers; and
receiving the information associated with the one or more answers from the external source.

17. The method of claim 16, further comprising:
integrating the information associated with the one or more answers to the section of the document; and
providing a prompt that describes the information associated with the one or more answers and the external source.

18. A computer-readable memory device with instructions stored thereon for providing interactive generation of content for a document, the instructions comprising:
detecting an intent to create a section of the document based on one or more of an input and an inference;
presenting a content structure template based on the section of the document, wherein the content structure template includes one or more questions associated the section of the document;
receiving one or more answers to the one or more questions; and
generating the section of the document based on the one or more answers.

19. The computer-readable memory device of claim 18, wherein the instructions further comprise:
playing one or more audio output streams that include one or more questions of the content structure template;
capturing one or more audio input streams as the one or more answers to the one or more questions;
converting the one or more audio input streams into one or more text data; and
processing the one or more text data as the one or more answers to the one or more questions.

20. The computer-readable memory device of claim 18, wherein the instructions further comprise:
querying an external source for information associated with one or more answers;
receiving the information associated with the one or more answers from the external source;
integrating the information associated with the one or more answers to the section of the document; and
providing a prompt that describes the information associated with the one or more answers and the external source.
